(19) United States
(12) Patent Application Publication
(10) Pub. No.: US 2013/0120885 A1
(43) Pub. Date: May 16, 2013

(54) LOW NOISE ESD PROTECTION FOR SOCs WITH ANALOG OR RADIO FREQUENCY DEVICES

(71) Applicants: Mansour Keramat, Santa Clara, CA (US); Tim Kuo, Santa Clara, CA (US)

(72) Inventors: Mansour Keramat, Santa Clara, CA (US); Tim Kuo, Santa Clara, CA (US)

(21) Appl. No.: 13/297,236

(22) Filed: Nov. 15, 2011

(51) Int. Cl. H02H 9/04

(52) U.S. Cl. 361/56

(57) ABSTRACT

Systems and methods are disclosed to reduce pin count in an integrated circuit with digital and analog circuits on-chip by receiving power (VDD) input at a digital power input pad that provides electrostatic discharge (ESD) protection but substantially no current for on-chip analog circuits; filtering noise from the digital power input pad with a filter; and coupling a low noise analog power input pad internal to the integrated circuit to the filter and an analog circuit or a low noise singled ended radio frequency circuit without requiring an external analog power pin.

### BACKGROUND

The present application relates to low noise electrostatic discharge protection for single-ended analog or radio frequency (RF) devices.

As semiconductor technology advances into the nanometer-scale integrated circuit arena and more and more features are built into communication and RF chips, the capacity of integrated circuits are increasing. This is also because integration of large-scale digital logics with high performance analog/mixed signal contents onto a single chip (SoC) has been increasingly the demand and trend of circuit designs. The evolution towards nanometer CMOS technologies (90 nm, 65 nm, and below) enables the design of complex Systems on a Chip (SoC) in consumer-market applications such as telecom (e.g. wireless) and multimedia. Such integrated systems are increasingly mixed-signal in nature, embedding high-performance analog or mixed-signal blocks and possibly sensitive RF frontends together with complex digital circuitry (multiple processors, logic blocks, and large memory blocks) on the same chip. The percentage of SoC designs that contain analog circuits is only growing. Integrating the analog/RF parts together with the digital circuitry on a single die allows reducing the overall system cost and power, and improves the overall system performance.

To increase the production yield and the quality of the end products the circuit designers have to take into account the package circuitries during their design phase. This leads to the demand for SoC and system-in-package (SiP) design. Both SoC and SiP designs are very challenging especially due to the high sensitivity of analog portion to any changes in the whole circuit.

Traditionally, digital circuit is noisy and if mixed with analog circuits can cause poor noise performance for the analog circuitry. To avoid introducing noise into the analog section of the SoC or SiP, designers have provided separate power and ground domains for the digital circuitry and the analog circuitry to achieve wide dynamic range with good signal-to-noise performance. However, such separation requires extra external power pins for analog power and digital power, respectively. Due to high integration, a separate analog power pin is undesirable from pin-out considerations.

### SUMMARY

In one aspect, a digital integrated circuit (IC) with analog circuits thereon includes a digital power input pad to receive power (VDD) input, wherein the digital power input pad provides electrostatic discharge (ESD) protection but provides substantially no current for the analog circuits; a low noise analog pad internal to the integrated circuit and coupled to the analog circuits; and a filter positioned between the digital power input pad and the low noise analog pad.

In another aspect, a digital integrated circuit (IC) with analog radio frequency (RF) circuits thereon includes a digital power input pad to receive power (VDD) input, wherein the digital power input pad provides electrostatic discharge (ESD) protection but provides substantially no current for the analog RF circuits; a low noise analog pad internal to the integrated circuit and coupled to the analog RF circuits; and a filter positioned between the digital power input pad and the low noise analog RF pad.

In yet another aspect, a method to reduce pin count in an integrated circuit with digital and analog circuits on-chip includes receiving power (VDD) input at a digital power input pad that provides electrostatic discharge (ESD) protection but substantially no current for on-chip analog circuits; filtering noise from the digital power input pad with a filter; and coupling a low noise analog power input pad internal to the integrated circuit to the filter and an analog circuit or a low noise singled ended radio frequency circuit without requiring an external analog power pin.

In yet another aspect, a digital integrated circuit (IC) with radio frequency circuits thereon includes a digital power input pad to receive power (VDD) input, wherein the digital power input pad provides electrostatic discharge (ESD) protection but provides no current for on-chip circuits; a low noise RF pad internal to the integrated circuit and coupled to a single ended radio frequency circuit; and a filter positioned between the digital power input pad and the low noise RF pad.

In a further aspect, a method to reduce pin count in an integrated circuit with digital and radio frequency (RF) circuits on-chip includes receiving power (VDD) input at a digital power input pad that provides electrostatic discharge (ESD) protection but no current for on-chip circuits; filtering noise from the digital power input pad with a filter; and coupling a low noise RF power input pad internal to the integrated circuit to the filter and a low noise singled ended radio frequency circuit without requiring an external RF power (VDDRF) pin.

Advantages of the preferred embodiment may include one or more of the following. The single-ended RF input is advantageous compared to differential circuit since an external balun transformer can be eliminated; therefore, the cost will be lower. The system provides noise rejection as the single-ended circuit can be sensitive to noise coupling. For SOC (system-on-a-chip), where sensitive RF and digital circuit are placed on the same die, the noise coupling issue can be much more severe than conventional multi-chip solution, with the ESD structure potentially a major source of such digital noise coupling in the SOC. The preferred embodiment reduces such noise coupling while maintaining the same ESD performance. An extra pin is not required, and IC real estate saving is achieved.

### BRIEF DESCRIPTION OF THE DRAWING

An appreciation of the features and benefits of the present invention and a more complete understanding of its structure may be had by studying the following description of the preferred embodiment and by referring to the accompanying drawings.

FIG. 1 shows an exemplary circuit to provide Low Noise ESD for Single-Ended RF Input.

### DESCRIPTION

The term “NFET” refers to an N-type metal oxide semiconductor field effect transistor. Likewise, when used herein, “PFET” refers to a P-type metal oxide semiconductor field effect transistor. It should be appreciated that whenever the terms, “NFET”, “PFET”, and “transistor,” are used, unless otherwise expressly indicated or dictated by the nature of their use, they are being used in an exemplary manner. They encompass the different varieties of MOS devices including devices that don't literally use “metal”, i.e., using another suitable material in place of metal such as polysilicon, and devices with different VTs and oxide thicknesses to mention just a few. Moreover, unless specifically referred to as MOS or the like, the term transistor can include other suitable transistor types, e.g., junction-field-effect transistors, bipolar-junction transistors, and various types of multi-gated transistors, known today or not yet developed.

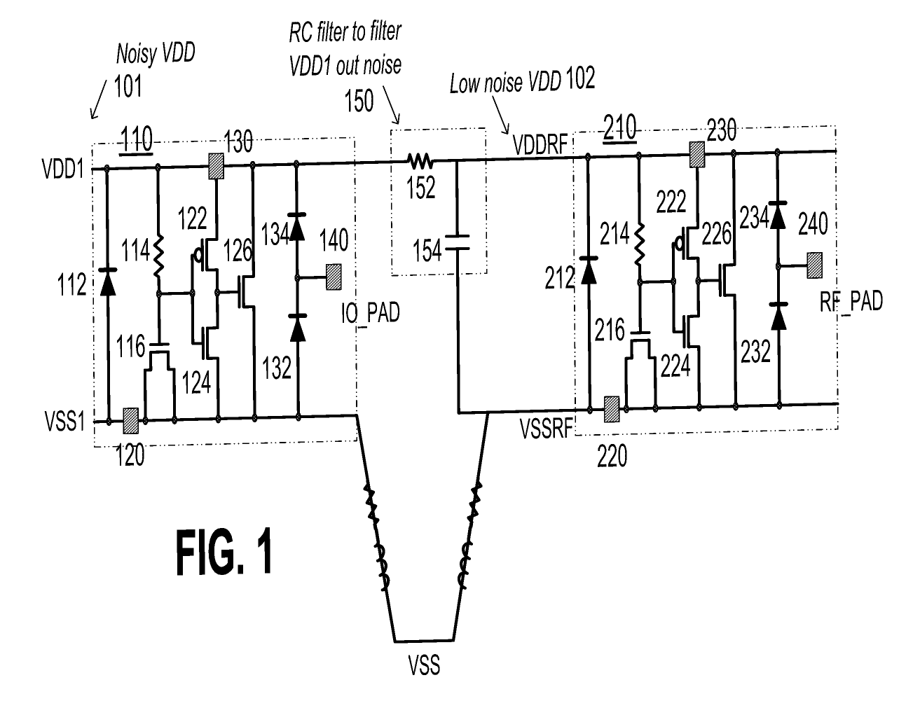

FIG. 1 shows an exemplary circuit to provide Low Noise ESD for Single-Ended RF Input. The circuit includes a digital portion 110 and an analog portion 210. In the digital portion 110, noisy digital supply voltage (VDD1) 101 and ground (VSS1) are provided to diode 112. Also connected to the VDD1 101 is resistor 114, which is connected to transistor 116. Pad 120 is positioned between VSS1 and transistor 116. The resistor is also connected to transistor pairs 122-124. Transistor 122 is connected to VDD pad 130. The output of transistor pairs 122-124 acts as a clamp signal that turns on/off transistor 126. A pair of diodes 132-134 provides ESD protection for IO pad 140.

During ESD event, diode 134 will turn on and conduct current for any input voltage greater than VCC+Vd, where Vd is the forward diode drop. Similarly, diode 132 will clamp any negative voltage below VSS−Vd. If the chip is not powered up and an ESD pulse is incident between the input and, say, VSS, the voltage will be clamped at either the reverse breakdown voltage of the diode for a positive pulse or at −Vd for a negative pulse. When an ESD voltage is applied to the input structure, the on-chip diodes shunt the transient current to the power line (VCC) or ground. A positive transient voltage causes diode 134 to be forward biased when the input voltage exceeds VCC. Likewise, for negative transients, diode 132 shunts the negative current. The polysilicon input resistors serve to limit the peak currents. Since polysilicon resistors are thermally insulated by a surrounding layer of SiO2 or glass they are particularly susceptible to thermal damage resulting from joule heating by ESD induced currents.

For the sensitive RF input pad 240, VDD pad 230 is inserted only for ESD purpose, but not for supplying current to on-chip blocks. Any VDD pad that supplies on-chip block can be noisy due to large amount of nwell connection on the chip. Therefore, a VDD pad that does not supply current reduces the noise pick-up dramatically. However, during normal operation, the ESD diode 240 should be reversed biased to lower its capacitance and avoid being turned on. The common practice is to have a dedicated pinout for VDDRF and keep this pin as clean as possible by proper pin assignment and PCB design. However, this will add an extra pin, therefore, increase the form factor of the chip and also the cost. The circuit of FIG. 1 connects VDDRF 102 through a noisy VDD pad 130. In this case, no dedicated VDDRF pin is necessary. However, in order to reduce the amount of noise, the circuit uses an R-C network 150 with resistor 152 and capacitor 154 to filter the unwanted noise and reduce the noise coupling. Since there is no current needed on VDDRF pin, using an R-C network reduces noise considerably in a space efficient manner. This approach avoids external RC filter, thus resulting in additional cost savings for the SoC customers.

In the analog portion 210, low noise analog supply voltage (VDDRF) 102 and ground (VSSRF) are provided to diode 212. Also connected to the VDDRF 102 is resistor 214, which is connected to transistor 216. Pad 220 is positioned between VSSRF and transistor 216. The resistor is also connected to transistor pairs 222-224. Transistor 222 is connected to VDDRF pad 230. The output of transistor pairs 222-224 acts as a clamp signal that turns on/off transistor 226. A pair of diodes 232-234 provides ESD protection for RF pad 240.

The single-ended RF input of FIG. 1 is advantageous compared to differential circuit since an external balun transformer can be eliminated; therefore, the cost will be lower. The system provides noise rejection as the single-ended circuit can be sensitive to noise coupling. For SOC (system-on-a-chip), where sensitive RF and digital circuit are placed on the same die, the noise coupling issue can be much more severe than conventional multi-chip solution, with the ESD structure potentially a major source of such digital noise coupling in the SOC. The preferred embodiment reduces such noise coupling while maintaining the same ESD performance. An extra pin is not required, and IC real estate saving is achieved.

In another implementation that does not use diode, PMOS and NMOS devices can be used, with the drain substrate junctions taking the place of the diodes. One major difference is that the drain substrate junction reverse breakdown triggers the MOS device into a snapback mode in which the drain voltage drops due to the turn-on of the lateral parasitic bipolar transistor formed by the drain, channel, and source regions. The output buffer is self-protecting, i.e., the transistors of the output buffer serve as the protection circuit.

It should be noted that the depicted system could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the figures for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. A digital integrated circuit (IC) with analog circuits thereon, comprising:
a digital power input pad to receive power (VDD) input, wherein the digital power input pad provides electrostatic discharge (ESD) protection but provides substantially no current for the analog circuits;
a low noise analog pad internal to the integrated circuit and coupled to the analog circuits; and
a filter positioned between the digital power input pad and the low noise analog pad.

2. The IC of claim 1, comprising and ESD diode coupled to the digital power input pad, wherein the ESD diode is reversed biased to lower the ESD diode capacitance and avoid being turned on.

3. The IC of claim 1, comprising a VDD power pin coupled to the digital power input pad.

4. The IC of claim 1, wherein the digital power input pad comprises:
a first shunt device to discharge positive polarity transients;
a second shunt device to discharge negative polarity transients; and
a current limiting clamp coupled to the first and second shunt devices.

5. The IC of claim 1, wherein the digital power input pad is coupled to a digital ground, and wherein the analog pad is coupled to an analog ground through a resistor inductor network.

6. The RF circuit of claim 5, comprising a diode positioned between the VDD input and ground.

7. The RF circuit of claim 1, wherein the analog pad comprises a single-ended radio frequency input.

8. The RF circuit of claim 1, wherein the analog circuit comprises a single ended radio frequency circuit.

9. The RF circuit of claim 1, wherein the analog pad comprises a radio frequency pad.

10. A digital integrated circuit (IC) with analog radio frequency (RF) circuits thereon, comprising:
a digital power input pad to receive power (VDD) input, wherein the digital power input pad provides electrostatic discharge (ESD) protection but provides substantially no current for the analog RF circuits;
a low noise analog pad internal to the integrated circuit and coupled to the analog RF circuits; and
a filter positioned between the digital power input pad and the low noise analog RF pad.

11. A method to reduce pin count in an integrated circuit with digital and analog circuits on-chip, comprising:
receiving power (VDD) input at a digital power input pad that provides electrostatic discharge (ESD) protection but substantially no current for on-chip analog circuits;
filtering noise from the digital power input pad with a filter; and
coupling a low noise analog power input pad internal to the integrated circuit to the filter and an analog circuit or a low noise singled ended radio frequency circuit without requiring an external analog power pin.

12. The method of claim 11, comprising minimizing noise coupling from the ESD structure while providing ESD protection.

13. The method of claim 11, comprising operating an ESD diode coupled to the digital power input pad in a reversed biased mode to lower the ESD diode capacitance and avoid turning the diode on.

14. The method of claim 13, comprising operating a second ESD diode coupled to the analog power input pad in a reversed biased mode to lower the ESD diode capacitance and avoid turning the diode on.

15. The method of claim 11, comprising coupling a VDD power pin to the digital power input pad.

16. The method of claim 11, comprising connecting a single-ended RF input to the analog pad.

17. The method of claim 11, wherein the analog circuit comprises a single ended radio frequency circuit.

18. The method of claim 11, wherein the analog pad comprises a radio frequency pad.

19. The method of claim 11, comprising coupling a low noise radio frequency input pad internal to the integrated circuit to the filter without requiring the external analog power pin.

20. The method of claim 11, comprising limiting current with a series element.
